(19) United States
(12) Patent Application Publication
(10) Pub. No.: US 2026/0200702 A1
(43) Pub. Date: Jul. 16, 2026

(54) HINGED CONNECTOR FOR ELEVATOR SUSPENSION MEMBER

(71) Applicant: OTIS ELEVATOR COMPANY, Farmington, CT (US)

(72) Inventors: Bardia Guilani, Woodstock Valley, CT (US); Antonio Martins, Vernon, CT (US)

(21) Appl. No.: 19/021,451

(22) Filed: Jan. 15, 2025

(51) Int. Cl. B66B 7/12; B66B 19/00

(52) U.S. Cl. CPC B66B 7/1223; B66B 19/00

(57) ABSTRACT

An elevator connector includes a first body portion and a second body portion that is selectively moveable relative to the first body portion between an open position and a closed position. At least one metal contact is supported by one of the first body portion and the second body portion. A plurality of openings are formed within one of the first body portion and the second body portion, and a plurality of metal members are selectively insertable within the plurality of openings. The at least one metal contact engages at least one tension member of an elevator suspension member and each metal member contacts another tension member of the elevator suspension member to establish electrically conductive connections with associated tension members when the second body portion is in the closed position.

### BACKGROUND

Elevator systems are in widespread use for carrying passengers between various levels in buildings, for example. Some elevator systems are traction-based in which a suspension assembly, sometimes referred to as roping, suspends the elevator car and a counterweight. The suspension assembly also facilitates movement of the elevator car when needed. Traditional suspension assemblies include round steel ropes. More recently, elevator systems have included other types of suspension members, such as flat belts or other types of ropes that have multiple steel cords encased in a compressible polymer jacket.

Traditional round steel ropes were typically inspected using a manual process including manually and visually observing the condition of the outer surfaces of the rope. Coated belts and other coated ropes cannot be inspected that way. Electrical inspection techniques have been developed that include applying electric current to at least some of the steel strands and measuring an electrical characteristic, such as resistance, to obtain information indicating a condition of the belt or coated rope. Connectors are used to connect the coated belts to a monitoring device. The connection should be secure and have a good connection interface.

### SUMMARY

An illustrative example elevator connector includes: a first body portion; a second body portion selectively moveable relative to the first body portion between an open position and a closed position; at least one metal contact supported by one of the first body portion and the second body portion; a plurality of openings formed within one of the first body portion and the second body portion; and a plurality of metal members selectively insertable within the plurality of openings, wherein the at least one metal contact engages at least one tension member of an elevator suspension member and each metal member contacts another tension member of the elevator suspension member to establish electrically conductive connections with associated tension members when the second body portion is in the closed position.

In addition to one or more of the features described herein, or as an alternative, the first body portion is connected to the second body portion by at least one hinge.

In addition to one or more of the features described herein, or as an alternative, the at least one metal contact is embedded within the one of the first body portion and the second body portion.

In addition to one or more of the features described herein, or as an alternative, the at least one metal contact comprises at least first and second metal contacts embedded with the one of the first body portion and the second body portion.

In addition to one or more of the features described herein, or as an alternative, the first and second metal contacts are outward of the plurality of openings across a width of the first body portion and the second body portion.

In addition to one or more of the features described herein, or as an alternative, each of the first body portion and the second body portion include an exterior surface and an interior surface when in the closed position, and wherein each interior surface includes a recessed area that receives an end of the elevator suspension member.

In addition to one or more of the features described herein, or as an alternative, at least one of the first body portion and the second body portion includes at least one male locking member that is selectively receivable within at least one female locking member formed in the other of the first body portion and the second body portion to lock the second body portion in the closed position.

In addition to one or more of the features described herein, or as an alternative, each of the plurality of openings is surrounded by a cylindrical wall to form tubular portions that receive the plurality of metal members.

In addition to one or more of the features described herein, or as an alternative, the plurality of metal members comprise fasteners.

An illustrative example assembly includes: a connector comprising a first body portion and a second body portion selectively moveable relative to the first body portion between an open position and a closed position; a suspension member extending along a center axis and comprising a plurality of tension members encased in a jacket, the suspension member having one end received within the connector when in the closed position; at least one metal contact supported by one of the first body portion and the second body portion; a plurality of openings formed within one of the first body portion and the second body portion; and a plurality of metal fasteners selectively insertable within the plurality of openings, wherein the at least one metal contact engages one tension member of an elevator suspension member and each metal fastener contacts another tension member to establish electrically conductive connections with the plurality of tension members when the second body portion is in the closed position.

In addition to one or more of the features described herein, or as an alternative, an elevator car is supported by the suspension member to facilitate movement of the elevator car, and wherein the connector connects an electric-based monitor to the suspension member.

In addition to one or more of the features described herein, or as an alternative, the first body portion is connected to the second body portion by at least one hinge.

In addition to one or more of the features described herein, or as an alternative, the at least one metal contact comprises at least a first metal contact and a second metal contact that are both embedded within the second body portion.

In addition to one or more of the features described herein, or as an alternative, the center axis extends along a length of the suspension member, and the plurality of tension members comprise a plurality of cords that are spaced apart from each other across a width of the suspension member from a first edge to a second edge opposite of the first edge, and wherein the first metal contact is adjacent to the first edge and the second metal contact is adjacent to the second edge when in the closed position, and wherein the first metal contact and the second metal contact are outward of the plurality of openings across a width of the connector.

In addition to one or more of the features described herein, or as an alternative, at least one of the first body portion and the second body portion includes at least one male locking member that is selectively receivable within at least one female locking member formed in the other of the first body portion and the second body portion to lock the second body portion in the closed position.

An illustrative example method includes: forming an elevator connector by attaching a first body portion to a second body portion with at least one hinge; embedding at least a first metal contact and a second metal contact in one of the first body portion and the second body portion, the first metal contact and the second metal contact each being configured to contact at least one tension member of an elevator suspension member; and forming a plurality of openings within one of the first body portion and the second body portion that are each configured to receive a metal fastener that is engageable with another tension member of the elevator suspension member.

In addition to one or more of the features described herein, or as an alternative, the method includes forming overlapping recessed areas in each of the first body portion and the second body portion that are configured to receive one end of the elevator suspension member.

In addition to one or more of the features described herein, or as an alternative, the method includes integrally forming at least one male locking member with the first body portion and integrally forming at least one female locking member with the second body portion.

An illustrative example method of connecting an electric-based monitor to the elevator suspension member with the elevator connector includes: forming the elevator suspension member to extend along a center axis and to include a plurality of tension members encased in a jacket, wherein the plurality of tension members are spaced apart from each other across a width of the elevator suspension member from a first edge to a second edge opposite of the first edge; inserting the one end of the elevator suspension member into one overlapping recessed area of the first body portion; folding the second body portion to overlap the first body portion such that the first metal contact engages an outermost tension member at the first edge and the second metal contact engages an outermost tension member at the second edge to establish electrically conductive connections with the outermost tension members; and inserting one metal fastener of the plurality of metal fasteners into one opening of the plurality of openings to establish electrically conductive connections with the plurality of tension members that are between the outermost tension members.

In addition to one or more of the features described herein, or as an alternative, the method includes inserting the at least one male locking member into at least one female locking member as the second body portion is folded over the first body portion to lock the first body portion and the second body portion together.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates a portion of an example suspension member.

FIG. 3 is a perspective view of a connector used to connect to a suspension member, where the connector is in an open position.

FIG. 4 is a section view of the connector of FIG. 3 when the connector is in a closed position.

FIG. 5 is a flowchart diagram of an example implementation of a method of forming a connector.

### DETAILED DESCRIPTION

Health monitoring of elevator suspension members, such as coated steel belts (CSB) for example, requires an interface between cords in the CSB and the health monitoring device, e.g., an electrical/electronic device. Embodiments of this disclosure provide an interface the includes a connector that enables the electrical connection of the cords with monitoring device inputs. This provides a critical connection to the cords in a robust manner and prevents unintended shorting of cords during application of the connector.

FIG. 1 schematically illustrates selected portions of an elevator system 10. An elevator car 12 is supported by a roping arrangement or suspension assembly 14 that includes a plurality of suspension members 16. The elevator car 12 is coupled to a counterweight 22 by the suspension members 16. The suspension members 16 move around one or more sheaves 18 as the elevator car 12 moves between landings or levels along a hoistway 80.

At least one of the sheaves may be a traction sheave 24 that is driven by a machine 26 to move the suspension members 16 around the traction sheave 24. Some of the other sheaves 18 may include diverter, deflector or idler sheaves that help guide the suspension members 16 around various components of the elevator system 10. The example of FIG. 1 shows a 1:1 roping arrangement in which the one or more suspension members 16 terminate at the car 12 and counterweight 22; however, other roping arrangements may also be used.

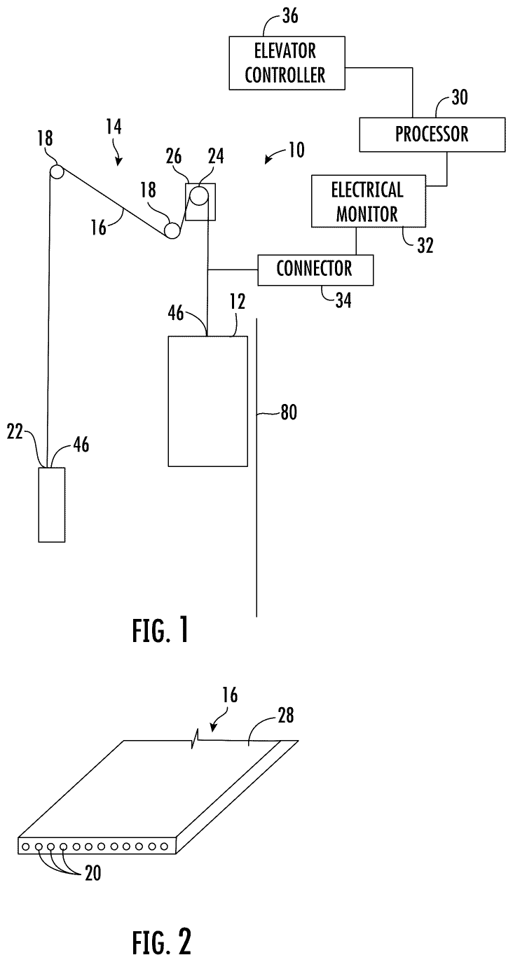

In some implementations, the suspension members 16 are flat belts or other types of ropes that have tension members 20 encased in a jacket 28 as shown in FIG. 2, for example.

In some implementations, a suspension member monitoring device includes at least one processor 30 that is configured to determine a condition of each of the suspension members 16. The processor 30 in the illustrated example includes a computing device and associated memory. The processor 30 is programmed or otherwise configured to use different types of information indicative of the respective conditions of the suspension members 16 and a combination of criteria to determine when it is desirable or necessary to remove any one of the suspension members 16 from service.

An electric-based monitor 32 uses an electrical inspection technique and generates or provides a corresponding indication regarding a condition of each suspension member 16. The processor 30 receives the indication from the electric-based monitor 32 and communicates with an elevator controller 36.

In some example embodiments, the electric-based monitor 32 is configured to apply electricity to at least one of the tension members, such as a steel cord 20, of each suspension member 16, and to detect or measure the electrical resistance of the tension member. Changes in the electrical resistance indicate changes in a condition of the suspension member 16. Such resistance-based inspection techniques are known and need not be further described here.

FIG. 2 schematically illustrates a portion of an example suspension member 16. In the illustrated embodiment, the suspension member 16 is a flat belt including the plurality of cords or tension members 20 encased in the jacket 28, which is made of a compressible material, such as polyurethane. In many embodiments, the tension members 20 comprise steel cords. Other embodiments include tension members that are made of different materials. The electrical inspection technique takes advantage of the electrically conductive nature of the tension members 20.

A connector 34 is used to connect the electric-based monitor 32 to an associated suspension member 16 (FIG. 1). In one example, the electric-based monitor 32 wirelessly communicates the electrical resistance information to the processor 30.

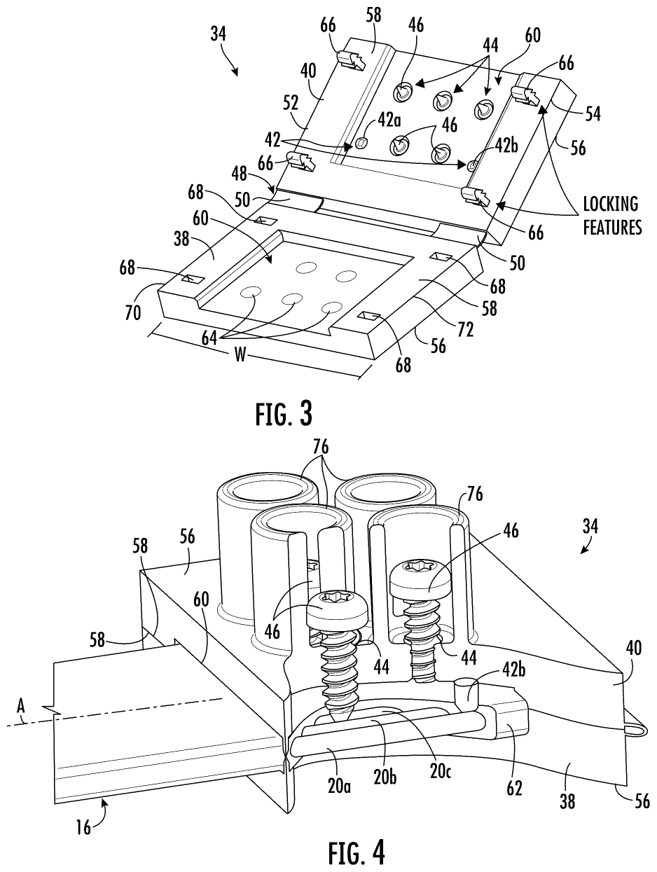

FIGS. 3-4 show one example of the connector 34. In some implementations, the connector 34 includes a first body portion 38 and a second body portion 40 that is selectively moveable relative to the first body portion 38 between an open position (FIG. 3) and a closed position (FIG. 4). One or more metal contacts 42 are supported by one of the first body portion 38 and the second body portion 40. In one example, a plurality of openings 44 are formed within one of the first body portion 38 and the second body portion 40. The plurality of openings 44 are configured to receive a plurality of metal members 46 that are selectively insertable within the plurality of openings 44. The one or more metal contacts 42 engage at least one tension member 20 of the suspension member 16 and each metal member 46 contacts another tension member 20 to establish electrically conductive connections with associated tension members 20 when the second body portion 40 is in the closed position.

In one example, the plurality of openings 44 are formed in the second body portion 40 as shown in FIG. 3.

In some implementations, the first body portion 38 is connected to the second body portion 40 by at least one hinge 48 in a clamshell configuration.

In one example, the hinge 48 comprises a living hinge; however, other types of hinges could also be used.

In one example, the hinge 48 comprises one or more hinge portions 50 that are separate from each other.

In some implementations, the metal contacts 42 are embedded within one of the first body portion 38 and the second body portion 40.

In one example, the metal contacts comprise pins, tabs, or other similar structures.

In one example, the metal contacts 42 are insert molded with one of the first body portion 38 and the second body portion 40; however, other molding techniques may also be used.

In the example shown in FIG. 3, the metal contacts 42 are embedded within the second body portion 40.

In one example, the metal contacts comprise a first metal contact 42a adjacent to a first edge 52 of the second body portion 40 and a second metal contact 42b adjacent to a second edge 54 of the second body portion 40 that is opposite of the first edge 52.

In one example, the first 42a and second 42b metal contacts are outward of the plurality of openings 44 in a direction that is across a width W of the first body portion 38 and the second body portion 40.

In one example, each of the first body portion 38 and the second body portion 40 include an exterior surface 56 and an interior surface 58 when in the closed position. In some implementations, each interior surface 58 includes a recessed area 60 that receives one end 62 of the suspension member 16 as shown in FIG. 4.

In one example, the first 42a and second 42 metal contacts are embedded within the recessed area 60 of the second body portion 40.

In one example, the plurality of openings 44 are formed within the recessed area 60 of the second body portion 40.

In one example, the first 42a and second 42 metal contacts are outward of the plurality of openings 44 in a direction across the width W.

In one example, the first body portion 38 may include pockets or divots 64 that are formed within the recessed areas 60. The divots 64 may be aligned with the openings 44 when in the closed position.

In some implementations, one of the first body portion 38 and the second body portion 40 may include one or more male locking members 66 that are receivable within one or more female locking members 68 formed in the other of the first body portion 38 and the second body portion 40. When the male locking members 66 are inserted into the female locking members 68, the second body portion 40 and the first body portion 38 are locked together in the closed position.

In some implementations, the first body portion 38 and the second body portion 40 may include both male locking members 66 and female locking members 68.

In some implementations, the connector 34 may be a tamper-evident connector or one-time-use connector. These types of connectors are designed to ensure that once they are engaged and locked, any attempt to reopen or remove them will visibly damage or destroy the mechanism, preventing re-use.

For example, the connector may be configured for a one-time assembly where the connector cannot be reassembled once removed. Any attempt to disengage or reopen the connector would result in visible damage. This type of connector ensures a firm, reliable connection during its intended use and will permanently deform, break, or otherwise become non-functional upon disassembly.

In one example, there are two male locking members 66 formed on the interior surface 58 of the second body portion 40 along the first edge 52 and two male locking members 66 formed on the interior surface 58 of the second body portion 40 along the second edge 54. Similarly, there are two female locking members 68 formed on the interior surface 58 of the first body portion 38 along a first edge 70 and two female locking members 68 formed on the interior surface 58 of the first body portion 38 along a second, opposite, edge 72. It should be understood, that fewer or additional locking members could be provided as needed.

In one example, the male locking members 66 and the female locking members 68 are located out of, e.g., away from, the recessed areas 60.

In one example, the male locking members 66 comprise barbs, tabs, legs, snaps, or other similar extensions.

In one example, the female locking members 68 comprises openings, slots, recesses, or other similar receptacles.

In some implementations, each of the plurality of openings 44 is surrounded by a cylindrical wall 76 to form tubular portions that receive the plurality of metal members 46.

In one example, the plurality of metal members 46 comprise fasteners such as screws or other similar fasteners, for example.

As shown in FIG. 4, the suspension member 16 has one end 62 that is received within the connector 34 when in the closed position. When in this position, the second metal contact 42b engages an outermost tension member 20a and each metal member 46 is inserted between a pair of adjacent tension members 20b, 20c. The first metal contact 42a would engage an outermost tension member (not shown) along the opposite edge of the suspension member 16 in a manner similar to that of the second metal contact 42b.

In one example, each metal contact 42 only engages a single outermost tension member and the metal members 46 engage the tension members 20 between the outermost tension members. In one example, each metal member 66 engages only two tension members.

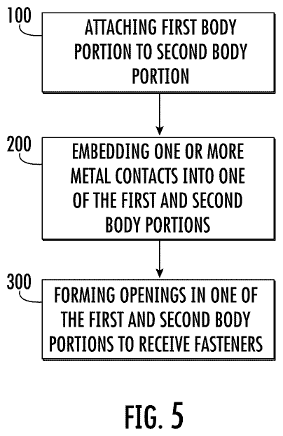

In one example, the disclosure provides a method that includes the following steps. An elevator connector 34 is formed by attaching a first body portion 38 to a second body portion 40 with at least one hinge 48 as indicated at 100 in FIG. 5. Next, the method includes embedding one or more metal contacts 42 in one of the first body portion 38 and the second body portion 40, where each metal contact is configured to contact at least one tension member of an elevator suspension member (see 200). Next, the method includes forming a plurality of openings 44 within one of the first body portion 38 and the second body portion 40 that are each configured to receive a metal member 46 that is engageable with another tension member of the elevator suspension member (see 300).

The method may include any of the additional steps either alone or in any combination thereof.

In one example, the method may include forming overlapping recessed areas 60 in each of the first body portion 38 and the second body portion 40 that are configured to receive one end 62 of the elevator suspension member 16.

In one example, the method may include integrally forming at least one male locking member 66 with the first body portion 38 and integrally forming at least one female locking member 68 with the second body portion 40.

In one example, the subject disclosure provides for a method of connecting an electric-based monitor to the elevator suspension member with the elevator connector 34. The method may include: inserting the one end of the elevator suspension member into one overlapping recessed area of the first body portion; folding the second body portion to overlap the first body portion such that the first metal contact engages an outermost tension member at the first edge and the second metal contact engages an outermost tension member at the second edge to establish electrically conductive connections with the outermost tension members; and inserting one metal fastener of the plurality of metal fasteners into one opening of the plurality of openings to establish electrically conductive connections with the plurality of tension members that are between the outermost tension members.

In one example, the method may include inserting the at least one male locking member into at least one female locking member as the second body portion is folded over the first body portion to lock the first body portion and the second body portion together.

The subject disclosure provides a unique connector that incorporates features to prevent unintended shorting of tension members as a result of applying the connector to the end of the suspension member, e.g. a CSB. The connector features a hinged design that includes pre-set pins to connect to the outermost tension members of the CSB without shorting to adjacent tension members. The connector also includes features for easy and secure closure to ensure connection to the outermost tension members via the integrated pins, for example, and to the middle tension members using metal fasteners such as screws, for example.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator connector comprising:
a first body portion;
a second body portion selectively moveable relative to the first body portion between an open position and a closed position;
at least one metal contact supported by one of the first body portion and the second body portion;
a plurality of openings formed within one of the first body portion and the second body portion; and
a plurality of metal members selectively insertable within the plurality of openings, wherein the at least one metal contact engages at least one tension member of an elevator suspension member and each metal member contacts another tension member of the elevator suspension member to establish electrically conductive connections with associated tension members when the second body portion is in the closed position.

2. The elevator connector of claim 1, wherein the first body portion is connected to the second body portion by at least one hinge.

3. The elevator connector of claim 1, wherein the at least one metal contact is embedded within the one of the first body portion and the second body portion.

4. The elevator connector of claim 3, wherein the at least one metal contact comprises at least first and second metal contacts embedded with the one of the first body portion and the second body portion.

5. The elevator connector of claim 4, wherein the first and second metal contacts are outward of the plurality of openings across a width of the first body portion and the second body portion.

6. The elevator connector of claim 1, wherein each of the first body portion and the second body portion include an exterior surface and an interior surface when in the closed position, and wherein each interior surface includes a recessed area that receives an end of the elevator suspension member.

7. The elevator connector of claim 1, wherein at least one of the first body portion and the second body portion includes at least one male locking member that is selectively receivable within at least one female locking member formed in the other of the first body portion and the second body portion to lock the second body portion in the closed position.

8. The elevator connector of claim 1, wherein each of the plurality of openings is surrounded by a cylindrical wall to form tubular portions that receive the plurality of metal members.

9. The elevator connector of claim 8, wherein the plurality of metal members comprise fasteners.

10. An assembly comprising:
a connector comprising a first body portion and a second body portion selectively moveable relative to the first body portion between an open position and a closed position;
a suspension member extending along a center axis and comprising a plurality of tension members encased in a jacket, the suspension member having one end received within the connector when in the closed position;
at least one metal contact supported by one of the first body portion and the second body portion;
a plurality of openings formed within one of the first body portion and the second body portion; and
a plurality of metal fasteners selectively insertable within the plurality of openings, wherein the at least one metal contact engages one tension member of an elevator suspension member and each metal fastener contacts another tension member to establish electrically conductive connections with the plurality of tension members when the second body portion is in the closed position.

11. The assembly of claim 10, including an elevator car supported by the suspension member to facilitate movement of the elevator car, and wherein the connector connects an electric-based monitor to the suspension member.

12. The assembly of claim 10, wherein the first body portion is connected to the second body portion by at least one hinge.

13. The assembly of claim 10, wherein the at least one metal contact comprises at least a first metal contact and a second metal contact that are both embedded within the second body portion.

14. The assembly of claim 13, wherein the center axis extends along a length of the suspension member, and the plurality of tension members comprise a plurality of cords that are spaced apart from each other across a width of the suspension member from a first edge to a second edge opposite of the first edge, and wherein the first metal contact is adjacent to the first edge and the second metal contact is adjacent to the second edge when in the closed position, and wherein the first metal contact and the second metal contact are outward of the plurality of openings across a width of the connector.

15. The assembly of claim 10, wherein at least one of the first body portion and the second body portion includes at least one male locking member that is selectively receivable within at least one female locking member formed in the other of the first body portion and the second body portion to lock the second body portion in the closed position.

16. A method comprising:
forming an elevator connector by attaching a first body portion to a second body portion with at least one hinge;
embedding at least a first metal contact and a second metal contact in one of the first body portion and the second body portion, the first metal contact and the second metal contact each being configured to contact at least one tension member of an elevator suspension member; and
forming a plurality of openings within one of the first body portion and the second body portion that are each configured to receive a metal fastener that is engageable with another tension member of the elevator suspension member.

17. The method of claim 16, including forming overlapping recessed areas in each of the first body portion and the second body portion that are configured to receive one end of the elevator suspension member.

18. The method of claim 16, including integrally forming at least one male locking member with the first body portion and integrally forming at least one female locking member with the second body portion.

19. A method of connecting an electric-based monitor to the elevator suspension member with the elevator connector of claim 18, the method comprising:
forming the elevator suspension member to extend along a center axis and to include a plurality of tension members encased in a jacket, wherein the plurality of tension members are spaced apart from each other across a width of the elevator suspension member from a first edge to a second edge opposite of the first edge;
inserting the one end of the elevator suspension member into one overlapping recessed area of the first body portion;
folding the second body portion to overlap the first body portion such that the first metal contact engages an outermost tension member at the first edge and the second metal contact engages an outermost tension member at the second edge to establish electrically conductive connections with the outermost tension members; and
inserting one metal fastener of the plurality of metal fasteners into one opening of the plurality of openings to establish electrically conductive connections with the plurality of tension members that are between the outermost tension members.

20. The method of claim 19, including inserting the at least one male locking member into at least one female locking member as the second body portion is folded over the first body portion to lock the first body portion and the second body portion together.
